(19) United States
(12) Patent Application Publication
(10) Pub. No.: US 2025/0306898 A1
(43) Pub. Date: Oct. 2, 2025

(54) FIRMWARE UPDATE METHOD AND DISPLAY DEVICE SYSTEM

(71) Applicant: Lenovo (Beijing) Limited, Beijing (CN)

(72) Inventors: Shuang HAN, Beijing (CN); Zhiyong LU, Beijing (CN)

(21) Appl. No.: 19/049,814

(22) Filed: Feb. 10, 2025

(30) Foreign Application Priority Data
Mar. 29, 2024 (CN) 202410383622.0

(51) Int. Cl. G06F 8/65

(52) U.S. Cl. CPC G06F 8/65

(57) ABSTRACT

A firmware update method includes, in response to obtaining a target firmware update package from a host device, determining a target display device from at least two display devices that are cascaded with each other via one or more output interfaces and one or more input interfaces that support a same video signal protocol, and updating the target display device. Updating the target display device includes directly updating the target firmware update package to the target display device, or updating the target firmware update package to the target display device through one or more display devices between the target display device and the host device.

### CROSS-REFERENCE TO RELATED APPLICATION

This application claims priority to Chinese Patent Application No. 202410383622.0, filed on Mar. 29, 2024, the entire content of which is incorporated herein by reference.

### TECHNICAL FIELD

The present disclosure generally relates to the field of firmware update technologies and, more particularly, to a firmware update method and a display device system.

### BACKGROUND

When a user uses multiple monitors, the multiple monitors are often connected in a cascaded manner. When the firmware of one monitor needs to be upgraded, the user needs to directly connect the monitor to a host device to upgrade the firmware. This method is very cumbersome and does not support batch deployment.

### SUMMARY

In accordance with the disclosure, there is provided a firmware update method including, in response to obtaining a target firmware update package from a host device, determining a target display device from at least two display devices that are cascaded with each other via one or more output interfaces and one or more input interfaces that support a same video signal protocol, and updating the target display device. Updating the target display device includes directly updating the target firmware update package to the target display device, or updating the target firmware update package to the target display device through one or more display devices between the target display device and the host device.

Also in accordance with the disclosure, there is provided a display device system including a host device configured to output a target video signal and provide a target firmware update package, a first display device connected to the host device via a first communication interface protocol and configured to output the target video signal as display content, and a second display device connected in series to the first display device via a second communication interface protocol based on which a video signal is transmitted to the second display device via the first display device. The first display device is configured to transmit the target firmware update package provided by the host device to the second display device in response to a firmware update instruction for the second display device, and the second display device is configured to complete target firmware update operation based on the target firmware update package.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those ordinary in the art, other drawings can be obtained based on these drawings without any creative work.

FIG. 1 is a flowchart of a firmware update method consistent with embodiments of the present disclosure.

FIG. 2 is a flowchart of another firmware update method consistent with embodiments of the present disclosure.

FIG. 3 is a flowchart of another firmware update method consistent with embodiments of the present disclosure.

FIG. 4 is a schematic diagram of a display device system consistent with embodiments of the present disclosure.

FIG. 5 is a schematic diagram showing a daisy chain mode consistent with embodiments of the present disclosure.

FIG. 6 is a data flow diagram showing primary control upgrade consistent with embodiments of the present disclosure.

FIG. 7 is a schematic diagram showing upgrade package transmission consistent with embodiments of the present disclosure.

FIG. 8 is a schematic diagram showing a silent upgrade scenario consistent with embodiments of the present disclosure.

FIG. 9 is an extended schematic diagram showing a daisy chain mode consistent with embodiments of the present disclosure.

FIG. 10 is a schematic diagram of a firmware upgrade architecture consistent with embodiments of the present disclosure.

FIG. 11 is a schematic diagram showing firmware reverse flashing consistent with embodiments of the present disclosure.

FIG. 12 is another schematic diagram showing firmware reverse flashing consistent with embodiments of the present disclosure.

FIG. 13 is another schematic diagram showing firmware reverse flashing consistent with embodiments of the present disclosure.

FIG. 14 is a schematic hardware diagram of a computer apparatus consistent with embodiments of the present disclosure.

### DETAILED DESCRIPTION OF THE EMBODIMENTS

Embodiments of the present disclosure will be described below in connection with the drawings, to more clearly illustrate the technical solutions of the embodiments of the present disclosure. Obviously, the described embodiments are only part of the embodiments of the present disclosure, but not all of the embodiments. Based on the embodiments described in the present disclosure, all other embodiments obtained by those skilled in the art without making creative work are within the scope of the present disclosure.

In the following description, reference made to “some embodiments” refers to a subset of all possible embodiments. But it is understood that “some embodiments” may be the same subset or different subsets of all possible embodiments, and may be combined with each other without conflict. The terms “first/second/third” involved are merely to distinguish similar objects and do not represent a specific ordering of the objects. It is understandable that objects described by “first/second/third” may be interchanged with a specific order or sequence where permitted, such that the embodiments of the present disclosure described herein can be implemented in an order other than that illustrated or described herein.

Unless otherwise defined, all technical and scientific terms used herein have the same meaning as commonly understood by technicians in the technical field to which this application belongs. The terms used herein are for the purpose of describing the present disclosure only and are not intended to limit the scope of the present disclosure.

The present disclosure provides a firmware update method, which may be executed by a processor of a computer apparatus. The computer apparatus may be a server, a laptop, a tablet computer, a desktop computer, a smart TV, a set-top box, a mobile device (such as a mobile phone, a portable video player, a personal digital assistant, a dedicated messaging device, a portable gaming device), or other devices with data processing capabilities.

When a user uses two or more monitors, usually a first monitor is connected to a host device via a Universal Serial Bus (USB) or a Display Port (DP). A second monitor and subsequent monitors are connected via DP, and USB is not connected. When the second monitor or one subsequent monitor need to be updated with firmware, the user needs to unplug the DP cable of the monitor and connect the monitor to the host device for firmware update. This update method is very cumbersome, and the length of the DP cable may not support direct connection to the host device. When there are a large number of cascaded monitors, batch updates cannot be performed and can only be performed manually, which is not suitable for enterprise environments.

To solve the problem that the firmware update process is cumbersome when at least two display devices are cascaded with each other, the present disclosure provides a firmware update method, including: in response to obtaining a target firmware update package from a host device, determining a target display device from at least two display devices cascaded with each other; and directly updating the target firmware update package to the target display device, or, updating the target firmware update package to the target display device through a display device between the target display device and the host device. Therefore, when the at least two display devices are cascaded with each other, the firmware of the target display device may be updated directly through the host device, or through one of the at least two display devices, which solves the problem that the target display device needs to be directly connected to the host device for firmware update, maintains the original connection method of the at least two display devices, and the firmware update process is simple, which is suitable for users to deploy in batches.

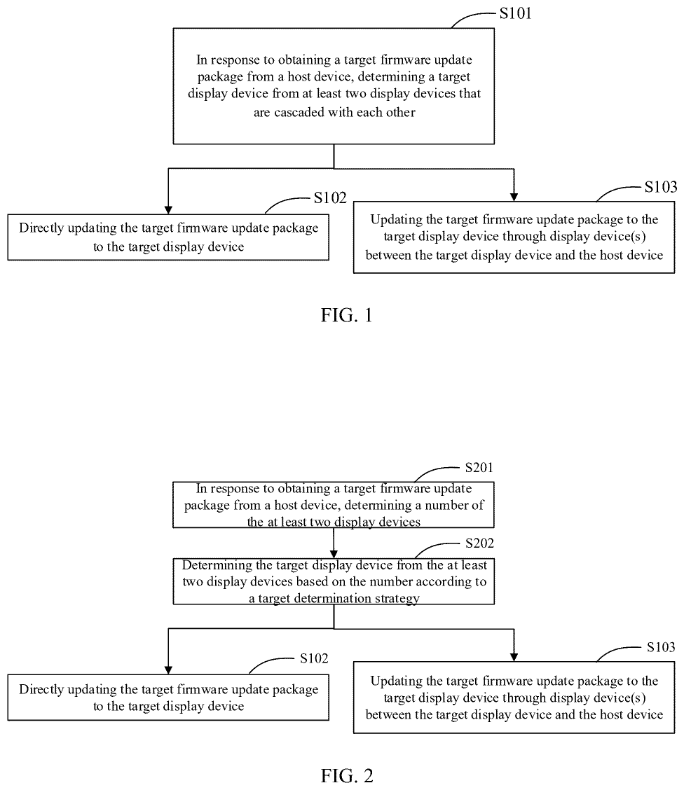

In one embodiment shown in FIG. 1, which is a flowchart of a firmware update method consistent with embodiments of the present disclosure, the method includes S101 to S103.

At S101, in response to a target firmware update package being obtained from a host device, a target display device is determined from at least two cascaded display devices, where the at least two display devices are cascaded through output interfaces and input interfaces that support a same video signal protocol.

The host device may be used to provide the firmware update package, and may be any device with a firmware update package sending function. Exemplarily, the host device may be a laptop, an all-in-one (AIO), a desktop computer, a tablet computer, a server, a mobile phone, etc.

The target firmware update package may be a firmware program that needs to be updated for the target display device, and may be used to implement the firmware update process of the target display device. One display device may implement a specific function by running one piece of internally stored firmware. Multiple pieces of firmware may be run in the display device, and each piece of firmware may implement a specific function. The firmware in the display device may need to be updated to improve the function in the display device. The firmware to be updated in the display device may be the target firmware.

The at least two display devices may be connected to each other in a cascaded manner. For example, three display devices and a host device may be connected to each other in a daisy chain topology. One end of a first display device may be connected in series to the host device and another end may be connected in series to a second display device. One end of the second display device may be connected in series to the first display device and another end may be connected in series to a third display device. One end of the third display device may be connected in series to the second display device.

The video signal protocol may be a protocol for transmitting video signals between two interconnected display device ports. For example, the video signal protocol may include at least one of a DP protocol for transmitting video signals between a DP input interface and a DP output interface, an HDMI protocol for transmitting video signals between an input interface and an output interface of a High Definition Multimedia Interface (HDMI), a DVI protocol for transmitting video signals between an input interface and an output interface of a Digital Visual Interface (DVI), or a VGA protocol for transmitting video signals between an input interface and an output interface of a Video Graphics Array (VGA).

In some embodiments, the target firmware update package may be stored in the host device. When the target firmware update package is obtained from the host device, the target display device may need to be determined from the at least two display devices cascaded with each other to update the target firmware update package to the target display device.

In some embodiments, the at least two display devices may be connected in series through output interfaces and input interfaces that support the same video signal protocol. For example, the at least two display devices may be cascaded through the DP output interfaces and the DP input interfaces. Since the video signal protocol may not be transmitted between USB interfaces, the input interfaces and output interfaces that support the same video signal protocol between the at least two display devices may be video interfaces that exclude USB interfaces, that is, the at least two display devices in the present disclosure may not be connected in series through USB interfaces.

In some embodiments, the target display device may be determined from the at least two display devices based on a target update instruction. The target update instruction may carry identification information of the target display device, and the target display device may be determined from the at least two display devices based on the identification information. For example, the target update instruction may carry the name of the target display device, and the target display device may be determined from the at least two display devices based on the name of the target display device.

In some embodiments, the target display device may be determined based on the target update instruction and the version information of the target firmware of the at least two display devices. For example, for one display device pointed to by the target update instruction, it may be further determined whether the version information of the target firmware of the display device is the latest version or the target version. When the version information of the target firmware of the display device is not the latest version or the target version, the display device may be determined as the target display device.

In some embodiments, the target display device may be determined based on the target update instruction and the operating status of the at least two display devices. For example, one display device in a hibernate state may be determined as the target display device. When one display device pointed to by the target update instruction is in a hibernate state, the display device in a hibernate state may be determined as the target display device.

In some embodiments, the target display device may be determined from the at least two display devices based on target reference information. The target reference information may include a target position of the target display device in the cascade structure, and one display device at the target position in the at least two display devices may be determined as the target display device. For example, the target reference information may include that the position of the target display device is at the third position in the cascade structure, and then the third display device in the cascade structure may be determined as the target display device.

In some embodiments, the target reference information may be the identification information of the target firmware update package, and one display device matching the identification information of the target firmware update package in the at least two display devices may be determined as the target display device. For example, the identification information of the target firmware update package may be the product model LX4022, and the product models of the at least two display devices may be compared with the identification information. Therefore, one display device matching the product model LX4022 may be determined as the target display device.

In some embodiments, the target reference information may be the digital signature key of the target firmware update package, and one display device matching the digital signature key of the target firmware update package in the at least two display devices may be determined as the target display device. For example, the digital signature key of the target firmware currently running in the at least two display devices may be compared with the digital signature key of the target firmware update package to determine the target display device.

At S102, the target firmware update package is directly updated to the target display device.

The target display device may be directly connected to the host device. When the target firmware update package is obtained from the host device, the target firmware update package may be directly updated to the target display device through the host device.

In some embodiments, the operating status of the target display device may be obtained, and the target firmware update package may be updated to the target display device based on the operating status. When the target display device is in a non-working state, the target firmware update package may be directly delivered or delivered in real time to the target display device such that the target display device performs the target firmware update operation.

In some embodiments, when the target display device is in a working state, the obtained target firmware update package may be transmitted to the target display device to perform the target firmware update operation when a target condition is triggered. The target condition may include that the target display device is in a standby state, a restart state, or reaches a specific time.

In some embodiments, when the target display device is in the working state, the target firmware update package may be transmitted to the target display device in response to the target condition being triggered such that it performs the target firmware update operation.

At S103, the target firmware update package is updated to the target display device through display device(s) between the target display device and the host device.

The target display device and the host device are connected through at least one display device, and when the target firmware update package is obtained from the host device, the target firmware update package may be updated to the target display device through the at least one display device.

In some embodiments, the target display device and the host device are connected through a first display device. The first display device may be a device directly connected to the host device, and is also referred to as a “direct-connection display device”. The operating status of each display device may be obtained, and the target firmware update package may be directly updated to the target display device directly connected in series to it through the first display device based on the operating status. When the target display device is in a non-working state, the target firmware update package may be directly delivered or delivered in real time to the target display device through the first display device, such that the target display device performs the target firmware update operation.

In some embodiments, when the target display device is in working state, the obtained target firmware update package may be transmitted to the target display device through the first display device, to perform the target firmware update operation when the target condition is triggered.

In some embodiments, the target display device may be connected to the host device through the first display device and at least one fifth display device. The at least one fifth display device may be a device connected in series to the first display device. The operating state of each display device may be obtained, and the target firmware update package may be updated to the target display device through the first display device and the at least one fifth display device based on the operating state. When the target display device is in the non-working state, the target firmware update package may be directly transmitted to the target display device through the first display device and the at least one fifth display device, such that the target firmware update operation is completed.

In some embodiments, when the target display device is in the working state, the target firmware update package may be stored in at least one of the first display device or the at least one fifth display device, such that the target firmware update package is transmitted to the target display device when the target condition is triggered and the target firmware update operation is performed.

In some embodiments, when the target firmware update package is transmitted between the output interfaces and the input interfaces of two adjacent display devices, an analog integrated circuit bus (Inter-Integrated Circuit, IIC) connection channel may be established between the output interfaces and the input interfaces based on an auxiliary channel (AUX CH). The AUC CH is a half-duplex channel. The protocol of the IIC connection channel is different from the video signal protocol (for example, the DP protocol for transmitting video signals), and may be used to transmit the target firmware update package.

In the embodiments of the present disclosure, in response to obtaining the target firmware update package from the host device, the target display device may be determined from the at least two display devices cascaded with each other. The target firmware update package may be directly updated to the target display device, or the target firmware update package may be updated to the target display device through the display device between the target display device and the host device. In this way, when the at least two display devices are cascaded with each other, the firmware of the target display device may be directly updated through the host device, and the firmware of the target display device may also be updated through the display device, which solves the problem that the target display device needs to be directly connected to the host device to perform the firmware update, maintains the original connection mode of the display devices, and the firmware update process is simple, which is suitable for users to deploy in batches.

In some embodiments, determining the target display device from the at least two mutually cascaded display devices may include: determining the target display device from the at least two display devices at least through a first display device, and updating the obtained target firmware update package to the target display device.

The first display device may be a device directly connected to the host device among the at least two display devices cascaded with each other, and the communication interface protocol between the first display device and the host device may be the same as or different from the communication interface protocol between the at least two display devices cascaded with each other. For example, the communication interface protocol between the first display device and the host device may be the USB protocol, and the communication interface protocol between the mutually cascaded display devices may be the DP protocol; or, the communication interface protocol between the first display device and the host device may be the DP protocol, and the communication interface protocol between the mutually cascaded display devices may be the DP protocol.

In some embodiments, when the host device is connected to the at least two display devices cascaded with each other, the target display device may be determined from the at least two display devices based on the identification information carried by the target update instruction. The target update instruction may be sent to the first display device through the host device, and the first display device may determine whether the identification information points to itself. When the first display device determines that the identification information points to itself, it may determine that the first display device is the target display device, and update the obtained target firmware update package to the first display device. When the first display device determines that the identification information points to the second display device, it may send the target update instruction to the second display device. When the second display device receives the target update instruction, it may determine that the identification information points to itself, determine that the second display device is the target display device, and update the target firmware update package to the second display device through the first display device.

In some embodiments, when the host device is connected to three or more display devices cascaded with each other, the target display device may be determined from the three or more display devices based on the target reference information, and the target reference information may include the target position. For example, the firmware of the display device at the third position in the cascaded display devices may be updated. The host device may send the target firmware update package carrying the target position to the first display device. After receiving the target firmware update package, the first display device may determine that its position is not the target position, and send the target firmware update package to the next display device, until the display device at the third position receives the target firmware update package, determines that its position is the target position, determines that the display device at the third position is the target display device, and updates the target firmware update package to the display device at the third position.

In the embodiments of the present disclosure, at least the first display device may determine the target display device from the at least two display devices, and update the obtained target firmware update package to the target display device. In this way, at least the first display device may accurately determine the target display device, and accurately update the target firmware update package to the target display device.

FIG. 2 is a flowchart of another firmware update method consistent with the present disclosure and may be executed by a processor of a computer apparatus. Based on FIG. 1, S101 may include S201 and S202.

At S201, in response to obtaining the target firmware update package from the host device, the number of display devices is obtained.

When the target firmware update package is obtained from the host device, it may be needed to determine the number of display devices in the at least two display devices cascaded with each other, and different numbers may correspond to different target determination strategies. The target display device may be determined from the at least two display devices according to the target determination strategy corresponding to the number of the display devices.

The number of the display devices may be obtained by counting the at least two display devices cascaded with each other.

At S202, based on the number, the target display device is determined from the at least two display devices using a corresponding target determination strategy.

The target determination strategy may be a strategy for determining the target display device, and different numbers of display devices may correspond to different target determination strategies.

In some embodiments, the target display device may be determined from the at least two display devices according to the target determination strategy based on the number of the display devices, by that: when the host device is connected to two display devices cascaded with each other, the target display device is determined from the two display devices at least based on the target update instruction, where the target update instruction at least includes an instruction for causing at least one of the two display devices to obtain the target firmware update package.

The target update instruction may be an instruction for triggering the display device to perform the firmware update, and the target update instruction may at least include an instruction for causing at least one of the two display devices to obtain the target firmware update package. The target update instruction may be a control signal, or triggered by inputting string data, button triggering, establishing a connection triggering, gesture, voice, etc., or it may be a network push trigger.

In some embodiments, the host device may be connected to two display devices cascaded with each other (for example, including a primary display device and a secondary display device), and the host device may only need to determine which display device of the two display devices to perform the firmware update, and update the target firmware update package to the target display device. Therefore, when the host device is connected to the two display devices cascaded with each other, the target display device may be determined from the two display devices based on the target update instruction. Whether the host device needs to update the secondary display device may be determined, and the target firmware update package may need to be sent to the display device to be updated.

In some embodiments, the target display device may be determined from the two display devices at least based on the target update instruction, by: determining a second display device of the two display devices as the target display device based on the identification information carried by the target update instruction.

The second display device may be a display device that matches the identification information carried by the target update instruction.

The identification information may be attribute information related to the target display device, and the identification information may be the name of the display device, the vendor ID, the product identity document (PID), the testing ID (TID), etc.

The target firmware may be updated directly according to the object pointed to by the target update instruction. The identification information carried by the target update instruction may be compared with the identification information in the two display devices, and the second display device that meets the identification information carried by the target update instruction may be determined as the target display device. For example, the identification information may be the name of the display device, and the name of the second display device of the two display devices may meet the name carried by the target update instruction. Therefore, the second display device may be determined as the target display device. The host device may send the target update instruction to the first display device, and the first display device may determine whether its own identification information matches the identification information carried by the target update instruction. When the identification information of the first display device matches the identification information carried by the target update instruction, the first display device may be determined to be the target display device. When the identification information of the first display device does not match the identification information carried by the target update instruction, it may be passed to the next display device for judgment.

In some embodiments, the target display device may be determined from the two display devices at least based on the target update instruction, by: determining the target display device based on the target update instruction and the operating status of the two display devices.

The operating status of the display device may include a hibernate state, a working state, or a restart state.

The target update instruction may point to the two display devices. When the two display devices pointed to by the target update instruction are determined, which display device is the target display device may be further determined by the operating status of the display devices. For example, one display device in the hibernate state may be determined as the target display device.

In some embodiments, the target display device may be determined from the two display devices at least based on the target update instruction, by: determining the target display device based on the target update instruction and the version information of the target firmware of the two display devices.

The target firmware may be the firmware that needs to be updated in the display device.

When one display device pointed to by the target update instruction is determined, whether the display device is the target display device may be further determined by the version information of the target firmware of the display device. For example, when the current target firmware version in the display device is not the target version or the latest version, the display device may be determined as the target display device.

In some embodiments, the target display device may be determined from the two display devices at least based on the target update instruction, by: determining the target display device based on the target update instruction and the evaluation information for the two display devices.

The evaluation information may be an evaluation or description of the functional experience, an evaluation or description of the security, or an evaluation or description of the display or sound output. For example, the evaluation information may be excellent functional experience, good functional experience, or poor functional experience.

When one display device pointed to by the target update instruction is determined, whether the display device is the target display device may be further determined by the evaluation information of the display device. For example, when the evaluation of the functional experience in the display device meets a preset evaluation standard (excellent functional experience), the display device may be determined as the target display device.

In the embodiments of the present disclosure, when the host device is connected to the two display devices cascaded with each other, the target display device may be determined from the two display devices at least based on the target update instruction, and the target update instruction may at least include the instruction for causing at least one of the two display devices to obtain the target firmware update package. Therefore, the target display device may be accurately determined from the two display devices. By determining the target display device from aspects such as identification information, the operating status of the display device, and evaluation information, the richness and accuracy of determining the target display device may be improved to meet the needs of users.

In some embodiments, the target display device may be determined from the at least two display devices according to the target determination strategy based on the number, by that: when the host device is connected to three or more mutually cascaded display devices, the target display device may be determined from the three or more display devices at least based on the target reference information, where the target reference information at least includes data that is able to characterize the uniqueness of the display devices.

The target reference information may be attribute information related to the target display device, and the target reference information may at least include data that is able to characterize the uniqueness of the display devices. The target reference information may include the position information of the target display device in the cascade structure, device identification information, device key signature, input update instruction, display status of the device, etc.

In some embodiments, the host device may be connected to three or more display devices (e.g., a primary display device and at least two secondary display devices) cascaded with each other. The host device may not know the position of the target display device to be updated in the cascade topology (e.g., a daisy chain). Therefore, it may be needed to determine the target display device from the three or more display devices based on the target reference information. When the relevant information of one display device matches the target reference information, the display device may be determined to be the target display device.

In some embodiments, determining the target display device from the three or more display devices at least based on the target reference information may include: determining one display device at a target position among the three or more display devices as the target display device, where the target position may be determined based on the target update task of the host device.

The target update task may be a task set in the host device to perform the target firmware update on the display device.

In some embodiments, the target position of the display device that needs to be updated with firmware may be directly set in the target update task.

In some embodiments, the relevant attributes of the display device that needs to be updated with firmware, such as the device model, may be set in the target update task, and the target position corresponding to the display device that needs to be updated with firmware may be determined based on the device model through communication between the host device and the three or more display devices. For example, the device model of the display device that needs to be updated with firmware may be LX4022, and the position of the display device with the device model of LX4022 may be determined as the target position through communication between the host device and the three or more display devices.

The target reference information may include the target position, and the target firmware update package may carry the target position. The target position may be compared with the positions corresponding to the three or more display devices, and the display device that matches the target position may be determined as the target display device. For example, the target position may be the third position, and the position of the third display device may match the target position, such that the third display device may be determined as the target display device. The host device may send the target firmware update package to the first display device, and the first display device may determine whether its own position information matches the position information carried by the target firmware update package. When the position information of the first display device matches the position information carried by the target firmware update package, the first display device may be determined to be the target display device. When the position information of the first display device does not match the position information carried by the target firmware update package, it may be passed to the next display device for judgment.

In some embodiments, the target display device may be determined from the three or more display devices at least based on the target reference information, by: determining a third display device among the three or more display devices as the target display device, where the third display device is a device that matches the identification information of the target firmware update package.

The identification information may be the model of the configuration file in the target firmware update package.

The target reference information may be the identification information of the target firmware update package, and the identification information of the target firmware update package (for example, the model of the configuration file) may be compared with the identification information (for example, the device model) corresponding to the three or more display devices, and the third display device that matches the identification information of the target firmware update package may be determined as the target display device.

In some embodiments, determining the target display device from the three or more display devices based at least on the target reference information by: determining a fourth display device among the three or more display devices as the target display device, where the fourth display device is a device that matches the encryption information of the target firmware update package.

The encryption information may be a digital signature key of the target firmware update package.

The target reference information may be the encryption information of the target firmware update package, and the encryption information of the target firmware update package (for example, the digital signature key) may be compared with the encryption information of the firmware (for example, the firmware key) respectively running in the three or more display devices, and the fourth display device that meets the key information of the target firmware update package may be determined as the target display device.

In some embodiments, the target display device may be determined from the three or more display devices at least based on the target reference information, by: determining the target display device based on the target reference information and the operating state of each display device.

The operating state of the display device may include a hibernate state, a working state, and a restart state.

When one display device pointed to by the target reference information is determined, whether the display device is the target display device may be further determined by the operating state of the display device. For example, one display device in the hibernate state may be determined as the target display device.

In some embodiments, the target display device may be determined from the three or more display devices at least based on the target reference information, by: determining the target display device based on the target reference information and the current firmware information of each display device.

The current firmware information may be the version information corresponding to the target firmware currently running in the display device.

When one display device pointed to by the target reference information is determined, whether the display device is the target display device may be further determined by the current firmware information of the display device. For example, when the version of the current target firmware in the display device is not the target version or the latest version, the display device may be determined as the target display device.

In some embodiments, the target display device may be determined from the three or more display devices at least based on the target reference information, by: determining the target display device based on the target reference information and the evaluation information for each display device.

The evaluation information may be an evaluation or description of the functional experience, an evaluation or description of the security, or an evaluation or description of the display or sound output. For example, the evaluation information may be excellent display performance, good display performance, or poor display performance.

When one display device pointed to by the target reference information is determined, whether the display device is the target display device may be further determined by the evaluation information of the display device. For example, when the evaluation of the functional experience in the display device meets the preset evaluation standard (excellent display performance), the display device may be determined as the target display device.

In the embodiments of the present disclosure, when the host device is connected to the three or more display devices that are cascaded to each other, the target display device may be determined from the three or more display devices based at least on the target reference information, and the target reference information may at least include the data that may characterize the uniqueness of the display devices. Therefore, the target display device may be accurately determined from the three or more display devices. And, by determining the target display device from aspects such as the target position of the display device, identification information of the target firmware update package, encryption information, operating status of the display device, and evaluation information, the richness and accuracy of determining the target display device may be improved to meet the needs of users.

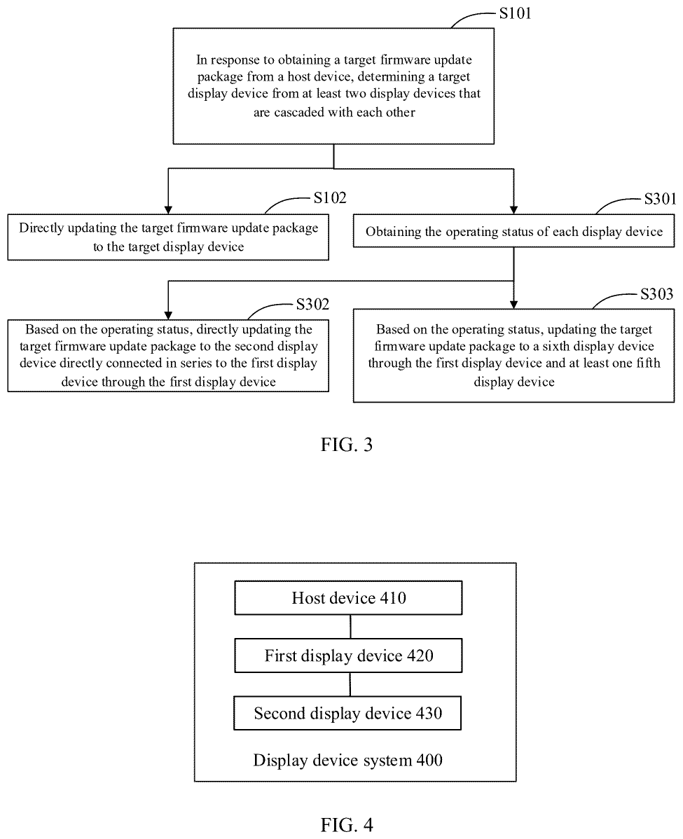

In another embodiment shown in FIG. 3, which is a flowchart of another firmware update method consistent with the present disclosure and may be executed by a processor of a computer apparatus, S103 in FIG. 1 includes S301 to S303.

At S301, the operating status of each display device is obtained.

The operating status of the display device may include a hibernate state, a working state, or a restart state.

In some embodiments, the operating status of the target display device may affect the update of the target firmware in the target display device. The target display device may only perform the firmware update operation when it is in a non-working state. Therefore, it may be needed to obtain the operating status of each display device, and update the target firmware update package to the target display device based on the operating status.

At S302, based on the operating status, the target firmware update package is directly updated to a second display device directly connected in series to the first display device.

The second display device may be the target display device and may be directly connected in series to the first display device. Based on the operating status of the first display device and the operating status of the second display device, the target firmware update package may be directly updated to the second display device directly connected in series to the first display device through the first display device. Since the second display device of the two display devices may be determined as the target display device based on the identification information carried by the target update instruction in the foregoing content, the target firmware update package may be directly updated to the second display device directly connected in series to the first display device here.

In some embodiments, when the first display device is in the second operating state and the second display device is in the second operating state, the stored target firmware update package may be directly delivered or delivered in real time to the second display device, such that the second display device performs the target firmware update operation.

The second operating state may be a non-working state, including a hibernate state or a restart state. When the target display device is in the second operating state, the target firmware update operation may be performed directly based on the target firmware update package through the target display device.

In some embodiments, when the first display device is in the second operating state and the second display device is in the second operating state, the target firmware update package may be obtained from the host device, and the target firmware update package may be stored in the first display device, and the stored target firmware update package may be directly delivered or delivered in real time to the second display device through the first display device. When the second display device receives the target firmware update package, it may directly perform the target firmware update operation because it may be in a non-working state.

The target firmware update package may be stored in a temporary storage area in the first display device such that the target firmware update package may be delivered to the second display device in real time through the first display device. For example, the temporary storage area may be a non-volatile random access memory (NVRAM).

The target firmware update package may be stored in a storage area in the first display device such that the target firmware update package may be delivered directly to the second display device through the first display device. For example, the storage area may be a read-only memory (ROM) or a flash memory.

In some embodiments, when the first display device is in a first operating state and the second display device is in a second operating state, the obtained target firmware update package may be transferred to the second display device to complete the target firmware update operation.

The first operating state may be a working state. When the target display device is in the first operating state, the target firmware update operation cannot be performed through the target display device.

When the first display device is in the first operating state and the second display device is in the second operating state, the first display device may store the obtained target firmware update package and transfer the target firmware update package to the second display device. When the second display device receives the target firmware update package, it may directly perform the target firmware update operation because it is in a non-working state.

In some embodiments, when the first display device is in the second operating state and the second display device is in the first operating state, the obtained target firmware update package may be transmitted to the second display device to perform the target firmware update operation when the target condition is triggered, or, in response to the target condition being triggered, the target firmware update package may be transmitted to the second display device to perform the target firmware update operation.

The target condition may be that the target display device is in a standby state or reaches a specific time. The specific time may be a time set according to actual conditions such as 2 a.m.

When the first display device is in the second operating state and the second display device is in the first operating state, the second display device cannot directly perform the target firmware update operation when receiving the target firmware update package, and may need to wait until the target condition is met before performing the target firmware update operation. In this case, the target firmware update package obtained by the first display device may be first transmitted to the second display device and stored until the target condition is triggered, such that the second display device directly performs the target firmware update operation. It may be also possible to wait until the target condition is triggered, and then transmit the target firmware update package in the first display device to the second display device such that it performs the target firmware update operation.

In some embodiments, when the first display device is in the first operating state and the second display device is in the first operating state, the obtained target firmware update package may be transmitted to the second display device to perform the target firmware update operation when the target condition is triggered, or, in response to the target condition being triggered, the target firmware update package may be transmitted to the second display device such that it performs the target firmware update operation.

The display state of the target display device may not change before and after updating the target firmware update package. For example, the display screen of the second display device before and after updating the target firmware update package may be consistent. In this way, a silent upgrade may be achieved.

In the embodiments of the present disclosure, when the first display device and the second display device are in different operating states, different methods may be used to update the target firmware update package stored in the first display device to the second display device. In this way, by considering the operating states of the display devices, the target display device may normally perform the target firmware update operation and realize silent upgrade.

At S303, based on the operating state, the target firmware update package is updated to a sixth display device through the first display device and at least one fifth display device, where the fifth display device is a device connected in series to the first display device.

The sixth display device may be the target display device and may be directly connected in series to the fifth display device, and at least the fifth display device may be connected in series between the first display device and the sixth display device. Based on the operating state of the sixth display device, the target firmware update package may be updated to the sixth display device through the first display device and at least the fifth display device.

In some embodiments, the sixth display device may be a device that matches the identification information of the target firmware update package, that is, the sixth display device may be the same device as the third display device. The sixth display device may not be the same device as the third display device in some other embodiments.

In some embodiments, the sixth display device may be a device that matches the encryption information of the target firmware update package, that is, the sixth display device may be the same device as the fourth display device. The sixth display device may not be the same device as the fourth display device in some other embodiments.

In some embodiments, the fifth display device may be the same device as the third display device, or may not be the same device as the third display device. The fifth display device may be the same device as the fourth display device, or may not be the same device as the fourth display device in some other embodiments.

In some embodiments, when the sixth display device is in the first operating state, the target firmware update package may be stored in at least one of the first display device or at least the fifth display device, such that when the target condition is triggered, the target firmware update package may be transmitted to the sixth display device to enable it to perform the target firmware update operation.

When the sixth display device is in the first operating state, the sixth display device cannot directly perform the target firmware update operation when receiving the target firmware update package, and may need to wait until the target condition is met before performing the target firmware update operation. In this case, the obtained target firmware update package may be first stored in at least one of the first display device or at least the fifth display device. Until the target condition is triggered, the stored target firmware update package may be transmitted to the sixth display device, such that it performs the target firmware update operation. The target firmware update package may be stored in the flash or ROM in the first display device and at least the fifth display device.

In some embodiments, when the sixth display device is in the first operating state, the target firmware update package may be transmitted to the sixth display device through the first display device and the fifth display device such that it directly performs the target firmware update operation when the target condition may be triggered.

When the sixth display device is in the first operating state, the sixth display device cannot directly perform the target firmware update operation when receiving the target firmware update package, and may need to wait until the target condition is met before performing the target firmware update operation. In this case, the target firmware update package may be first transmitted to the sixth display device and stored, and when the target condition is triggered, the sixth display device may perform the target firmware update operation based on the target firmware update package that has been received.

In some embodiments, when the sixth display device is in the second operating state, the target firmware update package may be directly transmitted to the sixth display device through the first display device and the fifth display device, such that it completes the target firmware update operation.

When the sixth display device is in the second operating state, the sixth display device may not be working at this time, and the target firmware update operation may be performed. Therefore, the target firmware update package may be directly transmitted to the sixth display device through the first display device and the fifth display device, such that it completes the target firmware update operation. The acquired target firmware update package may be pre-stored in the flash or ROM of any one of the first display device and at least the fifth display device, or may be pre-stored in the NVRAM of the display device directly connected in series to the sixth display device.

The display state of the target display device may not change before and after the target firmware update package is updated. The target display device may include a fifth display device or a sixth display device. For example, the display screen of the sixth display device before and after the target firmware update package is updated may be consistent. In this way, a silent upgrade may be achieved.

In the embodiments of the present disclosure, when the sixth display device is in different operating states, different methods may be used to update the target firmware update package to the sixth display device. In this way, by considering the operating state of the display device, the target display device may normally perform the target firmware update operation and achieve a silent upgrade.

In some embodiments, the method may further include: based on the operating state of each display device, storing the target firmware update package in the corresponding storage area of the first display device and/or at least one fifth display device, such that the target display device completes the target firmware update operation based on different data access paths.

The corresponding storage area may be an area in the display device for storing the target firmware update package. For example, the corresponding storage area may include flash or NVRAM.

Considering the operating state of the target display device, the target firmware update package may be stored in the corresponding storage area of the first display device and/or the at least one fifth display device.

In some embodiments, based on the operating state, the target firmware update package may be directly updated to the second display device directly connected in series through the first display device. When the second display device is in working state, the target firmware update package may be stored in the flash of the main control chip USB HUB in the first display device. When the second display device needs to perform a firmware update, the target firmware update package in the flash may be sent to the second display device. Or, the target firmware update package may be stored in the flash of the display control chip Scalar in the first display device, and when the second display device needs to perform a firmware update, the target firmware update package in the flash may be sent to the second display device. When the second display device is in the non-working state, the target firmware update package may be stored in the NVRAM of the display control chip Scalar in the first display device, and the target firmware update package in the NVRAM may be transmitted to the second display device in real time.

In some embodiments, the target firmware update package may be updated to the sixth display device through the first display device and the at least one fifth display device based on the operating status. When the sixth display device is in the working state, the target firmware update package may be stored in the flash of the main control chip USB HUB in the first display device, or the target firmware update package may be stored in the flash of the display control chip Scalar of any one of the first display device and the at least one fifth display device. When the sixth display device is in a non-working state, the target firmware update package may be stored in the NVRAM of the display control chip Scalar in the fifth display device directly connected in series to the sixth display device.

In the embodiments of the present disclosure, the target firmware update package may be stored in the corresponding storage area of the first display device and/or the at least one fifth display device based on the operating status of each display device. In this way, the target firmware update package may be differentially stored considering the operating status of the display device, such that the target display device completes the target firmware update operation based on different data access paths, thereby improving the flexibility and diversity of data access.

The present disclosure also provides a display device system. In one embodiment shown in FIG. 4, which is a display device system consistent with the present disclosure, the display device system 400 includes a host device 410, a first display device 420 and a second display device 430.

The host device 410 may be capable of outputting a target video signal and providing a target firmware update package.

The host device may be connected to the first display device and output a target video signal to the first display device through a first communication interface protocol. For example, the first communication interface protocol may be a USB protocol or a DP protocol.

The host device may be configured to store the target firmware update package, and, when a firmware update is required, the target firmware update package may be provided to the display device such that the target display device performs the target firmware update operation.

The first display device 420 may be connected to the host device through the first communication interface protocol, and may be configured to output the target video signal as display content.

The first display device may receive the target video signal output by the host device through the first communication interface protocol and output the target video signal as display content.

The second display device 430 may be connected in series to the first display device through a second communication interface protocol, and the second communication interface protocol may be used to transmit a video signal to the second display device through the first display device. The second communication interface protocol may be the same as or different from the first communication interface protocol.

The second display device may receive the video signal transmitted by the first display device based on the second communication interface protocol, and output the video signal as display content. For example, the second communication interface protocol may be the DP protocol.

The first display device may transmit the target firmware update package provided by the host device to the second display device when obtaining the firmware update instruction for the second display device, such that the second display device completes the target firmware update operation.

When the first display device receives the firmware update instruction provided by the host device, it may determine that the firmware update instruction is an instruction for performing the target firmware update on the second display device, and send the firmware update instruction to the second display device. The first display device may receive the target firmware update package from the host device, and transmit the target firmware update package to the second display device, such that the second display device completes the target firmware update operation.

When the first display device transmits the target firmware upgrade package to the second display device, an analog IIC connection channel may be established between the two display devices based on AUX CH, and the IIC connection channel may transmit the target firmware update package. The IIC protocol used to transmit the target firmware update package may be different from the DP protocol or HDMI protocol used to transmit the video signal, that is, the communication interface protocol used to transmit the video signal may be different from the communication protocol used to transmit the target firmware update package.

In some embodiments, the display device system may further include: a third display device connected in series to the second display device through a third communication interface protocol, where the third communication interface protocol is used to transmit a video signal to the third display device through the second display device.

The third display device may be connected in series to the second display device, receive the video signal sent by the second display device based on the third communication interface protocol, and output the video signal as display content. The third communication interface protocol may be the same as or different from the second communication interface protocol. For example, the third communication interface protocol may be a DP protocol or an HDMI protocol, etc.

The first display device and/or the second display device may transmit the target firmware update package provided by the host device to the third display device when obtaining a firmware update instruction for the third display device, such that it completes the target firmware update operation.

When the first display device and the second display device receive the firmware update instruction provided by the host device, the firmware update instruction may be determined to be an instruction for performing the target firmware update on the third display device, and the firmware update instruction may be sent to the third display device. The first display device may receive the target firmware update package from the host device and transmit the target firmware update package to the second display device, and the second display device may transmit the target firmware update package to the third display device, such that the third display device completes the target firmware update operation.

Additionally or alternatively, when the display device is in different operating states, the target display device may complete the target firmware update operation based on different access paths, and the target display device may be a device that needs to perform the target firmware update operation.

When the second display device needs to perform the target firmware update operation and is in a working state, the target firmware update package may be stored in the flash of the main control chip USB HUB in the first display device or the target firmware update package may be stored in the flash of the display control chip Scalar in the first display device. When the second display device needs to perform the firmware update, the target firmware update package in the flash may be obtained. When the second display device is in a non-working state, the target firmware update package may be stored in the NVRAM of the display control chip Scalar in the first display device, and the target firmware in the NVRAM may be received in real time.

When the third display device needs to perform the target firmware update operation and is in a working state, the target firmware update package may be stored in the flash of the main control chip USB HUB in the first display device, or the target firmware update package may be stored in the flash of the display control chip Scalar of any one of the first display device and the second display device. When the third display device is in a non-working state, the target firmware update package may be stored in the NVRAM of the display control chip Scalar in the second display device.

In some embodiments, the display device system may further include a fourth display device connected in series to the third display device through a fourth communication interface protocol, where the fourth communication interface protocol may be used to transmit a video signal to the fourth display device through the third display device.

The first display device, the second display device and/or the third display device may transmit the target firmware update package provided by the host device to the fourth display device when obtaining a firmware update instruction for the fourth display device, such that the fourth display device completes the target firmware update operation.

In some embodiments, the host device may determine the target display device from at least two display devices cascaded with each other, and directly update the target firmware update package to the target display device. The first display device may update the target firmware update package to the second display device, or transmit the target firmware update package to the second display device. The second display device may update the target firmware update package to the third display device, or transmit the target firmware update package to the third display device. The at least two display devices may be cascaded through output interfaces and input interfaces that support the same video signal protocol.

In some embodiments, the host device may determine the target display device from at least two display devices at least through the first display device, and update the obtained target firmware update package to the target display device. The first display device may be a device directly connected to the host device among the cascaded display devices, and the communication interface protocol between the first display device and the host device may be the same as or different from the communication interface protocol between the cascaded display devices.

In some embodiments, the host device may determine the number of the display devices, and determine the target display device from the at least two display devices based on the number according to the target determination strategy. The host device may determine the target display device from the two display devices at least based on the target update instruction when the host device is connected to the two display devices cascaded with each other, and the target update instruction may at least include an instruction for causing at least one of the two display devices to obtain the target firmware update package. The host device may determine the target display device from the three or more display devices at least based on the target reference information when the host device is connected to the three or more display devices cascaded with each other, and the target reference information may at least include data that is able to characterize the uniqueness of the display devices.

In some embodiments, the host device may be configured to: determine the second display device of the two display devices as the target display device based on the identification information carried by the target update instruction; determine the target display device based on the target update instruction and the operating status of the two display devices; determine the target display device based on the target update instruction and the version information of the target firmware of the two display devices; or determine the target display device based on the target update instruction and the evaluation information for the two display devices.

In some embodiments, the host device may be configured to: determine the display device at the target position among the three or more display devices as the target display device, where the target position may be determined based on the target update task of the host device; determine the device among the three or more display devices that matches the identification information of the target firmware update package as the target display device; determine the device among the three or more display devices that matches the encryption information of the target firmware update package as the target display device; determine the target display device based on the target reference information and the operating state of each display device; determine the target display device based on the target reference information and the current firmware information of each display device; or determine the target display device based on the target reference information and the evaluation information for each display device.

In some embodiments, the host device may obtain the operating state of the first display device, and directly update the target firmware update package to the first display device directly connected in series to it based on the operating state. The first display device may obtain the operating state of the second display device, and directly update the target firmware update package to the second display device directly connected in series to it based on the operating state. The second display device may obtain the operating state of the third display device, and directly update the target firmware update package to the third display device directly connected in series to it based on the operating state. The display state of the target display device may not change before and after the target firmware update package is updated.

In some embodiments, the first display device may directly or in real time transfer the stored target firmware update package to the second display device when the first display device is in the second operating state and the second display device is in the second operating state, such that the second display device performs the target firmware update operation. When the first display device is in the first operating state and the second display device is in the second operating state, the first display device may transfer the obtained target firmware update package to the second display device to complete the target firmware update operation. When the first display device is in the second operating state and the second display device is in the first operating state, the first display device may transmit the obtained target firmware update package to the second display device to perform the target firmware update operation when the target condition is triggered, or, in response to the target condition being triggered, transmit the target firmware update package to the second display device to perform the target firmware update operation.

In some embodiments, the second display device may store the target firmware update package when the third display device is in the first operating state, such that when the target condition is triggered, the target firmware update package is transmitted to the third display device to enable it to perform the target firmware update operation. When the third display device is in the first operating state, the target firmware update package may be transmitted to the third display device, such that when the target condition is triggered, it directly performs the target firmware update operation. When the third display device is in the second operating state, the target firmware update package may be transmitted to the third display device to enable it to complete the target firmware update operation.

Based on the operating state of the display device, the first display device, the second display device and the third display device may store the target firmware update package in the corresponding storage area, such that the target display device completes the target firmware update operation based on different data access paths.

The application of the firmware update method provided by the embodiments of the present disclosure in the actual scenarios is described below.

In the embodiments of the present disclosure, connection in the form of a daisy chain between multiple monitors through a video data cable may be formed, and the firmware of all devices on the daisy chain may be upgraded when the multiple monitors are not directly connected to a host.

When a user uses two or more monitors connected in the daisy chain, usually, the second, third, and fourth monitors are connected via DP, but not via USB, because the user's USB device is plugged into the first monitor. Further, when there is only a DP connection between the first monitor and the host, it is impossible to connect the USB cable to the subsequent monitors. When the firmware of one monitor on the daisy chain needs to be upgraded, the user needs to unplug the monitor signal cable and connect the monitor to the host for firmware upgrade, which is very inconvenient. Also, batch deployment is not supported and can only be operated manually, which is not suitable for enterprise environments. The third and fourth monitors are far away from the host, and the length of the signal cable does not support direct connection to the host.

In the embodiments of the present disclosure, the monitors on the daisy chain may be used to upgrade the firmware with each other, that is, instead of using a computer to upgrade the display firmware, the monitor Scalar may be used to upgrade the monitor Scalar firmware. In the embodiments of the present disclosure, when performing firmware upgrades on the monitors in the daisy chain, there may be no need to unplug the signal cable on the daisy chain, and there may be no need to connect each monitor directly to the host. The original connection method may be maintained, which is suitable for user batch deployment.

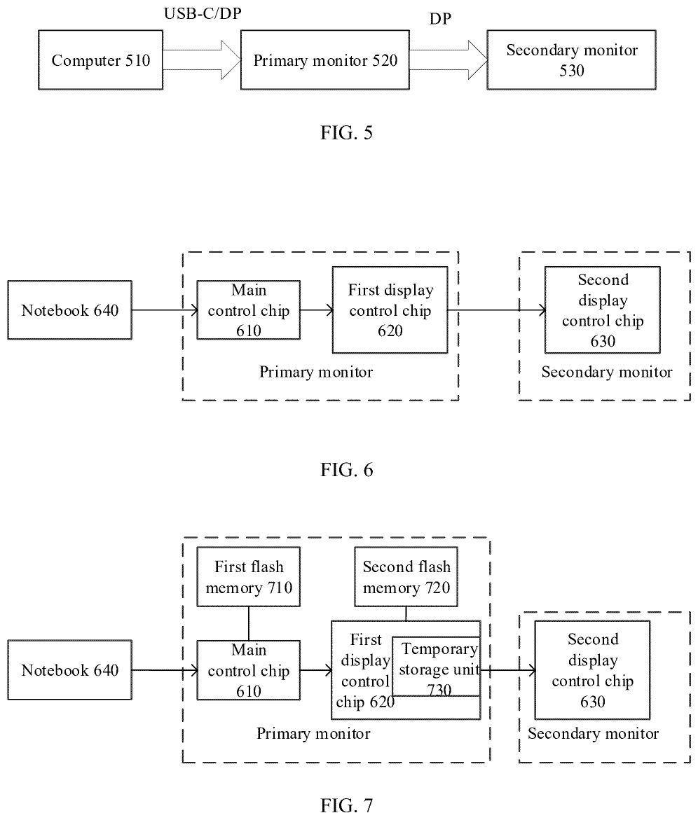

In FIG. 5, which is a schematic diagram showing a daisy chain mode consistent with embodiments of the present disclosure, the computer 510 is connected to the main monitor 520 via USB-C or DP, and the main monitor 520 is connected to the secondary monitor 530 via DP. When the main monitor 520 and the secondary monitor 530 are connected via DP without USB, the firmware of the secondary monitor cannot be upgraded in the related art.

As shown in FIG. 6 illustrating data flow of primary control upgrade consistent with embodiments of the present disclosure, the main monitor includes a main control chip 610 (USB HUB) and a first display control chip 620 (Scalar-1), and the secondary monitor includes a second display control chip 630 (Scalar-2). Based on FIG. 6, the notebook 640 sends an instruction to upgrade the firmware of the second monitor. After receiving the instruction, the USB HUB in the main monitor passes the instruction to Scalar-1. Scalar-1 establishes an analog IIC connection channel based on AUX CH at the DP output port. Scalar-1 sends a firmware upgrade instruction, Scalar-2 receives the instruction and starts the firmware upgrade initialization, and Scalar-1 acts as a burner to burn the firmware to Scalar-2.

FIG. 7 is a schematic diagram showing the upgrade package transmission consistent with the embodiments of the present disclosure. Based on FIG. 6, the main control chip is externally mounted with a first flash memory 710 (flash), the first display control chip is externally mounted with a second flash memory 720 (flash), and the first display control chip also has a temporary storage unit 730 (NVRAM). The upgrade package transmission includes three methods.

Method 1: After receiving the upgrade package, the USB HUB directly passes it to Scalar-1. After receiving the upgrade package, Scalar-1 divides it into small packages of a certain size (such as 64 KB) and temporarily stores it in NVRAM, and passes it to Scalar-2 in real time for firmware flashing.

Method 2: After receiving the upgrade package, the USB HUB stores it in the flash of Scalar-1. When flashing is required, Scalar-1 passes the upgrade package in the flash to Scalar-2 for flashing.

Method 3: After receiving the upgrade package, the USB HUB stores it in its own flash. When flashing is required, Scalar-1 passes the upgrade package in the flash of the USB HUB to Scalar-2 for flashing.

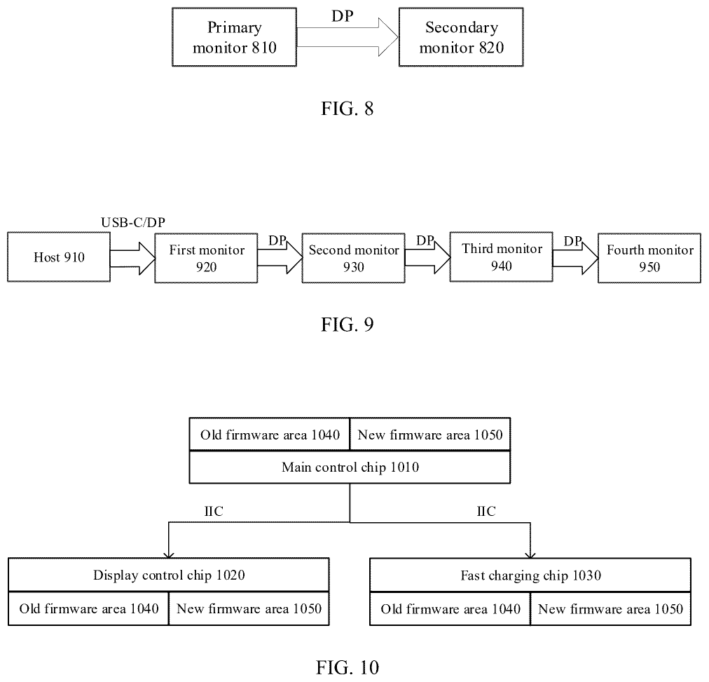

FIG. 8 is a schematic diagram showing the silent upgrade scenario consistent with the embodiments of the present disclosure. The main monitor 810 in FIG. 8 has two states: a working state and a non-working state. The secondary monitor 820 has two states: a working state and a non-working state. Based on FIG. 8, there are four silent upgrade methods for the following scenarios.

The first scenario is that the main display is not working and the secondary display is working:

Method A: The upgrade package is stored in flash based on method 2 or 3. When the secondary display enters a standby state or reaches a specific time, the upgrade package on the main monitor is transferred to the secondary monitor for updating.

Method B: The upgrade package is temporarily stored in NVRAM based on method 1 and first uploaded to the flash of the secondary monitor. When the secondary monitor enters the standby state or reaches a specific time, the secondary monitor calls the upgrade package on its own flash for firmware update.

The second scenario is that the main monitor is working and the secondary monitor is not working:
Method C: The upgrade package is stored in flash based on method 2 or 3. Scalar-1 transfers the upgrade package in flash to the flash of Scalar-2 to complete the update.

Method D: The upgrade package is temporarily stored in NVRAM based on method 1 and is transferred to Scalar-2 in real time for firmware flashing.

The third scenario is that neither the primary nor the secondary monitor is in the working state:
Method E: The upgrade package is passed to Scalar-2 based on methods 1, 2 or 3, and the Scalar-2 firmware is updated immediately after completion (i.e., the system is reset). Method E is consistent with methods C and D.

The fourth scenario is that both the primary and the secondary monitor are in the working state:
Method F: The upgrade package is stored in the primary monitor based on method 2 or 3, and the Scalar-2 firmware is updated immediately (i.e., the system is reset) when the secondary monitor enters the standby state or a specific time. Method F is consistent with method A.

Method G: The upgrade package is stored in the secondary monitor based on method 1, and the Scalar-2 firmware is updated immediately when the secondary monitor enters the standby state or a specific time. Method G is consistent with method B.

FIG. 9 is an extended schematic diagram showing a daisy chain mode consistent with embodiments of the present disclosure. As shown in FIG. 9, the host 910 is connected to the first monitor 920 via USB-C or DP, the first monitor 920 is connected to the second monitor 930 via DP, the second monitor 930 is connected to the third monitor 940 via DP, and the third monitor 940 is connected to the fourth monitor 950 via DP. Based on FIG. 9, when there are more than two monitors on the daisy chain, further expansion is required. Taking the firmware upgrade of the third monitor 940 of model LX4022 as an example, three methods may be used for firmware upgrade.

Method 4: The host communicates with the first monitor to obtain the position of the third monitor of model LX4022 in the daisy chain; after the first monitor receives the upgrade package, it notifies the second monitor that there is data transmission and burns the third monitor; and after the second monitor receives the data, it notifies the third monitor to burn the firmware.

Method 5: The host notifies the first monitor to burn the firmware. After receiving the upgrade package, the first monitor compares the configuration file (mainly the product model). When the model LX4022 in the configuration file is the same as the model of the first monitor, the firmware flashing is started. Otherwise, the first monitor passes the upgrade package to the next monitor. By analogy, the firmware flashing of the third monitor is completed.

Method 6: The host notifies the first monitor to burn the firmware. After receiving the upgrade package, the first monitor decrypts and obtains the key, and compares it with the firmware key running on the local machine. When they are the same, the flashing is performed. Otherwise, it is passed to the next monitor to repeat the work. By analogy, the firmware flashing of the third monitor is completed.

FIG. 10 is a firmware upgrade architecture diagram consistent with embodiments of the present disclosure. As shown in FIG. 10, the old firmware area 1040 and the new firmware area 1050 are provided in the main control chip 1010 (USB HUB), the monitor control chip 1020 (Scalar) and the fast charging chip 1030 (Power Delivery, PD). The main control chip 1010 communicates with the monitor control chip 1020 and the fast charging chip 1030 through the IIC protocol. Based on FIG. 10, the main control chip USB HUB notifies each upgraded chip to enter the firmware flashing mode, and the new firmware may be stored in the new firmware area. During the flashing process, each chip works normally; and, when the upgrade condition is triggered, each chip enters the firmware update mode, calls the new firmware as the running program, and restarts or resets the system.

In some embodiments, when the target component is the first functional component connected to the video interface in a display device, the first functional component may directly burn the target firmware update package into the first storage component connected to it. For example, the first functional component is a scalar or USB HUB, the video interface is a DP interface, and the scalar or USB HUB directly connected to the DP has its rom or flash directly mounted on its chip or uses the storage space in the chip to store firmware data. After receiving the target firmware update package, the target component directly burns the target firmware update package into the flash ROM storage area connected to the scalar or USB HUB. The display device can refer to any display device in the daisy chain.

In some embodiments, when the target component is a first functional component connected to a video interface in a display device, a first data transmission path between the first functional component and the first storage component may be opened through a first control circuit between the two, to burn the target firmware update package into the first storage component through the first data transmission path. For example, the first functional component is a scalar, the first control circuit is a multiplexer SPI MUX, a MUX switch is provided between the Scalar and its ROM, and the SPI MUX is set to A, that is, the scalar and the flash are connected, and the target firmware update package can be burned into the ROM through the connected first data transmission path. The display device may refer to any display device in a daisy chain.

In some embodiments, when the target component is a second functional component of a display device, a second data transmission path between the first functional component and the second functional component may be turned on through a second control circuit between the first functional component and the second functional component, to transmit the target firmware update package to the second functional component through the second data transmission path. For example, considering that the second functional component is a USB HUB, the first functional component is a scalar, a MUX switch is provided between the Scalar and the USB HUB, and the SPI MUX is placed in A, that is, the scalar is connected to the USB HUB, and the target firmware update package is transmitted to the USB HUB through the second data transmission path connected to the scalar and the USB HUB. The roles of the USB HUB controller and the scalar may be replaced. The scalar and the USB HUB are turned on or off by the mux switch. The second functional component may also be a PD controller. The display device can refer to any one of the display devices in the daisy chain.

In some embodiments, when the target component is a third functional component of the first display device or the second display device, a third data transmission path between the first functional component and the third functional component may be turned on through a second control circuit between the first functional component and the second functional component, and a third control circuit between the second functional component and the third functional component, to transmit the target firmware update package to the third functional component through the third data transmission path. For example, the third functional component is the PD controller of the first display device, the first functional component is scalar, the second functional component is USB HUB, there is SPI MUX1 between scalar and USB HUB, and there is SPI MUX2 between USB HUB and PD controller. When SPI MUX1 is set to A and SPI MUX2 is set to A, the path between scalar and USB HUB is turned on, the path between USB HUB and PD controller is turned on, and the path between scalar and USB HUB and the path between USB HUB and PD controller is turned on. The target firmware update package is transmitted from scalar to PD controller. The third functional component may be the PD controller of the first display device, or may be the scalar or USB hub of the second display device. The display device can refer to any display device in the daisy chain.

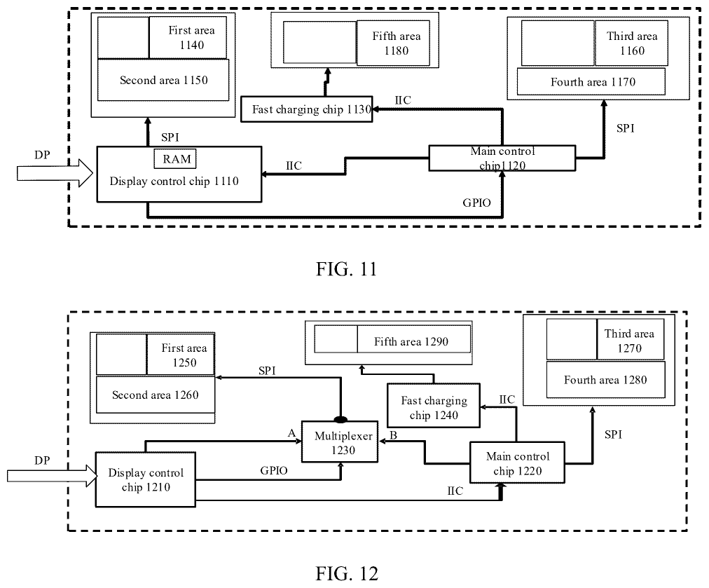

FIG. 11 is a schematic diagram showing firmware reverse flashing consistent with embodiments of the present disclosure. As shown in FIG. 11, a monitor includes a display control chip 1110 (Scalar), a main control chip 1120 (USB HUB) and a fast charging chip 1130 (USB-C PD). The Scalar chip receives its own firmware and burns the firmware directly into the first area 1140 of its own flash ROM. After receiving the firmware of the HUB and PD, the Scalar chip first burns the firmware into the second area 1150 of its own flash ROM as a temporary storage area. The second area temporarily stores the firmware of the HUB and PD. Scalar sends information through the general purpose I/O (GPIO) port to tell the USB HUB that there is a new firmware that needs to be updated. The USB HUB tells the scalar to read the firmware of the HUB and PD through IIC. Scalar reads the firmware in the second area and puts it into the RAM with a fixed address (pre-defined). The USB HUB reads the firmware from the RAM through IIC, and burns its own firmware into the third area 1160 of its own flash ROM, and the firmware of the PD is burned into the fourth area 1170. Through IIC, the firmware in the fourth area is passed to the USB-C PD chip, and the PD chip burns the firmware into the fifth area 1180 of its own flash ROM.

FIG. 12 is another schematic diagram showing firmware reverse flashing consistent with embodiments of the present disclosure. As shown in FIG. 12, one monitor includes a display control chip 1210 (Scalar), a main control chip 1220 (USB HUB), a multiplexer 1230 (SPI MUX) and a fast charging chip 1240 (USB-C PD). By default, the Scalar chip sets the SPI MUX to A through GPIO, that is, the scalar and the flash are connected. The Scalar chip receives its own firmware and burns the firmware directly into the first area 1250 of its own flash ROM. After the Scalar chip receives the HUB and PD firmware, it first burns the firmware into the second area 1260 in its own flash ROM as a temporary storage area. The Scalar chip sets the SPI MUX to B through GPIO, that is, the USB HUB and the flash are connected. At this time, the USB HUB learns that there is a new firmware that needs to be updated. The USB HUB directly reads the firmware in the second area, and its own firmware is burned into the third area 1270 of its own flash ROM, and the firmware belonging to the PD is burned into the fourth area 1280. Through IIC, the firmware of the fourth area is passed to the USB-C PD chip, and the PD chip burns the firmware into the fifth area 1290 in its own flash ROM.

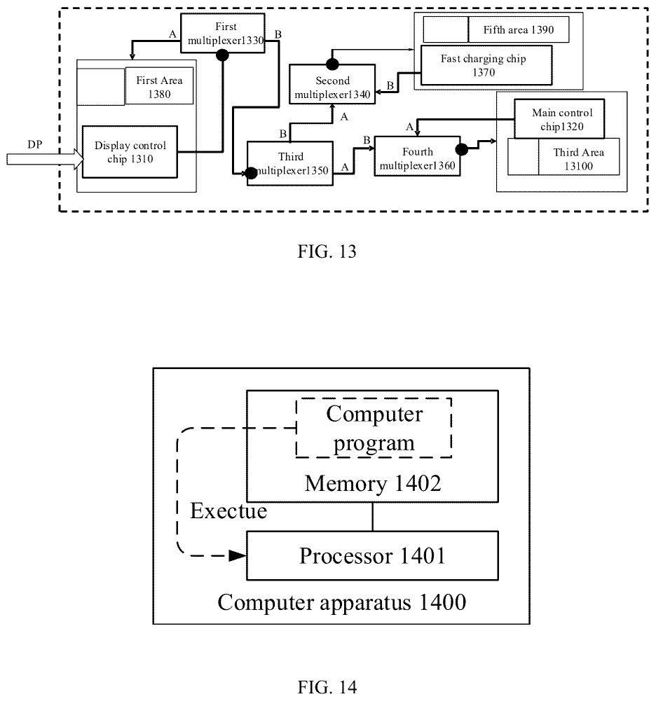

FIG. 13 is another schematic diagram showing firmware reverse flashing consistent with embodiments of the present disclosure. As shown in FIG. 13, the monitor includes a display control chip (1310) Scalar, a main control chip (1320) USB HUB, a first multiplexer (1330) SPI MUX1, a second multiplexer (1340) SPI MUX2, a third multiplexer (1350) SPI MUX3, a fourth multiplexer (1360) SPI MUX4 and a fast charging chip (1370) USB-C PD. By default, the Scalar chip sets SPI MUX1 to A through GPIO, that is, scalar and flash are connected. The Scalar chip receives its own firmware and burns the firmware directly into the first area 1380 of its own flash ROM. After the Scalar chip receives the PD firmware, it sets SPI MUX1 to B, SPI MUX3 to B, and SPI MUX2 to A through GPIO, connects scalar to PD flash, and burns the PD firmware to the fifth area 1390. After the flashing is complete, SPI MUX2 is set to B to restore the normal use of PD. After the Scalar chip receives the USB HUB firmware, it sets SPI MUX1 to B, SPI MUX3 to A, and SPI MUX4 to B through GPIO, connects scalar to USB HUB flash, and burns the HUB firmware to the third area 13100. After the flashing is complete, SPI MUX4 is set to A to restore the normal use of USB HUB.

In the present disclosure, when the above firmware update method is implemented in the form of a software function module and sold or used as an independent product, it can also be stored in a computer-readable storage medium. Based on this understanding, the technical solution of the embodiments of the present disclosure may be essentially or partly embodied in the form of a software product that contributes to the relevant technology. The software product may be stored in a storage medium, including several instructions to enable a computer apparatus (which can be a personal computer, server, or network device, etc.) to execute all or part of the methods provided by various embodiments of the present disclosure. The aforementioned storage medium may include a flash disk, a mobile hard disk, a read-only memory (ROM), a magnetic disk or optical disk, etc., which is able to store program code. In this way, the embodiments of the present disclosure are not limited to any specific hardware, software or firmware, or any combination of hardware, software and firmware.

The present disclosure provides a computer apparatus, including a memory and a processor. The memory may be configured to store a computer program that is able to be executed on the processor, and the processor may be configured to implement some or all of the steps in the above methods provided by various embodiments of the present disclosure when executing the program.

The present disclosure provides a computer-readable storage medium, on which a computer program is stored, and the computer program may implement some or all of the steps in the above methods provided by various embodiments of the present disclosure when executed by a processor. The computer-readable storage medium may be transient or non-transient.

The present disclosure provides a computer program, including computer-readable codes. When the computer-readable codes are executed in a computer apparatus, a processor in the computer device may be configured to implement some or all of the steps in the above methods provided by various embodiments of the present disclosure.

The present disclosure provides a computer program product, which includes a non-transient computer-readable storage medium storing a computer program. When the computer program is read and executed by a computer, some or all of the steps in the above methods provided by various embodiments of the present disclosure may be implemented. The computer program product may be implemented in hardware, software or a combination thereof. In some embodiments, the computer program product may be embodied as a computer storage medium. In other embodiments, the computer program product may be embodied as a software product, such as a software development kit (SDK), etc.

It should be pointed out here that the description of each embodiment above tends to emphasize the differences between the embodiments, and the same or similar aspects can be referenced to each other. The description of the above device, storage medium, computer program and computer program product embodiments is similar to the description of the above method embodiments, and has similar beneficial effects as the method embodiments. For technical details not disclosed in the embodiments of the device, storage medium, computer program and computer program product of the present application, references may be made to the description of the embodiment of the methods of the present disclosure.

FIG. 14 is a schematic hardware diagram of a computer apparatus. As shown in FIG. 14, the computer apparatus 1400 includes: a processor 1401 and a memory 1402. The memory 1402 may be configured to store a computer program that is able to be executed on the processor 1401, and the processor 1401 may be configured to implement any method provided by various embodiments of the present disclosure when executing the program.

The memory 1402 may be configured to store a computer program that is able to be executed on the processor. The memory 1402 may be configured to store instructions or applications executable by the processor 1401, and may also cache data to be processed or processed by the processor 1401 and each module in the computer device 1400 (for example, image data, audio data, voice communication data and video communication data), which may be implemented by flash memory (FLASH) or random access memory (RAM).

Any firmware update method provided by various embodiments of the present disclosure may be implemented when the processor 1401 executes the program. The processor 1401 generally controls the overall operation of computer apparatus 1400.

The present disclosure provides a computer storage medium, which stores one or more programs, which may be executed by one or more processors to implement any firmware update method provided by various embodiments of the present disclosure.

The processor may include at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, or a microprocessor. It can be understood that the electronic device that implements the above processor function may also be other devices, and the embodiments of the present disclosure is not specifically limited.

The above-mentioned computer storage medium/memory may include a read-only memory (ROM), a programmable read-only memory (PROM), an erasable programmable read-only memory (EPROM), an electrically erasable programmable read-only memory (EEPROM), a magnetic random access memory (FRAM), a flash memory, a magnetic surface memory, an optical disk, or a compact disc read-only memory (CD-ROM) and the like; it can also be various terminals including one or any combination of the above-mentioned memories, such as mobile phones, computers, tablet devices, personal digital assistants, etc.

Various embodiments have been described to illustrate the operation principles and exemplary implementations. Those skilled in the art would understand that the present disclosure is not limited to the specific embodiments described herein and there can be various other changes, rearrangements, and substitutions. Thus, while the present disclosure has been described in detail with reference to the above described embodiments, the present disclosure is not limited to the above described embodiments, but may be embodied in other equivalent forms without departing from the spirit and scope of the present disclosure.

What is claimed is:

1. A firmware update method comprising:
in response to obtaining a target firmware update package from a host device, determining a target display device from at least two display devices that are cascaded with each other via one or more output interfaces and one or more input interfaces that support a same video signal protocol; and
updating the target display device, including:
directly updating the target firmware update package to the target display device; or
updating the target firmware update package to the target display device through one or more display devices between the target display device and the host device.

2. The method according to claim 1, wherein:
determining the target display device includes determining the target display device from the at least two display devices at least through a direct-connection display device;
updating the target display device includes updating the target firmware update package to the target display device through the direct-connection display device; and
the direct-connection display device is one of the at least two display devices that is directly connected to the host device.

3. The method according to claim 2, wherein a communication interface protocol between the direct-connection display device and the host device is same as a communication interface protocol among the at least two display devices.

4. The method according to claim 2, wherein a communication interface protocol between the direct-connection display device and the host device is different from a communication interface protocol among the at least two display devices.

5. The method according to claim 1, wherein determining the target display device includes:
determining a number of the at least two display devices; and
determining the target display device from the at least two display devices based on the number according to a target determination strategy, including at least one of:
in response to the host device being connected to two display devices cascaded with each other, determining the target display device from the two display devices at least based on a target update instruction, the target update instruction at least including an instruction for enabling at least one of the two display devices to obtain the target firmware update package; or
in response to the host device being connected to three or more display devices cascaded with each other, determining the target display device from the three or more display devices at least based on target reference information, the target reference information at least including data that is able to characterize uniqueness of the display devices.

6. The method according to claim 5, wherein determining the target display device from the two display devices includes at least one of:
determining one display device of the two display devices as the target display device based on identification information carried by the target update instruction;
determining the target display device based on the target update instruction and an operating status of each of the two display devices;
determining the target display device based on the target update instruction and version information of target firmware of each of the two display devices; or
determining the target display device based on the target update instruction and evaluation information for each of the two display devices.

7. The method according to claim 5, wherein determining the target display device from the three or more display devices includes at least one of:
determining one of the three or more display devices that is at a target position as the target display device, the target position being determined based on a target update task of the host device;
determining one of the three or more display devices that matches identification information of the target firmware update package as the target display device;
determining one of the three or more display devices that matches the encryption information of the target firmware update package as the target display device;
determining the target display device based on the target reference information and the operating status of each of the three or more display devices;
determining the target display device based on the target reference information and current firmware information of each of the three or more display devices; or
determining the target display device based on the target reference information and evaluation information for each of the three or more display devices.

8. The method according to claim 1, wherein updating the target display device includes:
obtaining an operating status of each display device; and
updating the target firmware update package to the target display device based on the operating status, a display status of the target display device not changing before and after updating.

9. The method according to claim 8, wherein updating the target firmware update package to the target display device based on the operating status includes:
directly updating, based on the operating status and through a first display device directly connected to the host device, the target firmware update package to a second display device directly connected in series to the first display device.

10. The method according to claim 9, wherein updating the target firmware update package to the second display device includes at least one of:
in response to the first display device being in a first operating state and the second display device being in a second operating state, transferring the obtained target firmware update package to the second display device to complete target firmware update operation;
in response to both the first display device and the second display device being in the second operating state, transferring directly or in real time the stored target firmware update package to the second display device for the second display device to perform the target firmware update operation; or
in response to the first display device being in the second operating state and the second display device being in the first operating state:
transmitting the obtained target firmware update package to the second display device for the second display device to perform the target firmware update operation responding to triggering of a target condition; or
responding to the target condition being triggered, transmitting the target firmware update package to the second display device to enable the second display device to perform the target firmware update operation.

11. The method according to claim 9, further comprising:
storing the target firmware update package in a storage area of the first display device based on the operating status.

12. The method according to claim 8, wherein updating the target firmware update package to the target display device based on the operating status includes:
updating, based on the operating status and through a first display device directly connected to the host device and at least one second display device connected in series to the first display device, the target firmware update package to a third display device.

13. The method according to claim 12, wherein updating the target firmware update package to the third display device includes at least one of:
in response to the third display device being in a first operating state, storing the target firmware update package in at least one of the first display device or the at least one second display device, for the at least one of the first display device or the at least one second display device to transmit the target firmware update package to the third display device responding to triggering of a target condition for the third display device to perform target firmware update operation;
in response to the third display device being in the first operating state, transmitting the target firmware update package to the third display device through the first display device and the at least one second display device such for the third display device to directly perform the target firmware update operation responding to triggering of the target condition; or
in response to the third display device being in a second operating state, directly transmitting the target firmware update package to the third display device through the first display device and the at least one second display device for the third display device to complete the target firmware update operation.

14. The method according to claim 12, further comprising:
storing the target firmware update package in at least one of a storage area of the first display device or a storage area of the at least one second display device based on the operating status.

15. A display device system comprising:
a host device configured to output a target video signal and provide a target firmware update package;
a first display device connected to the host device via a first communication interface protocol and configured to output the target video signal as display content; and
a second display device connected in series to the first display device via a second communication interface protocol based on which a video signal is transmitted to the second display device via the first display device;
wherein the first display device is configured to transmit the target firmware update package provided by the host device to the second display device in response to a firmware update instruction for the second display device, and the second display device is configured to complete target firmware update operation based on the target firmware update package.

16. The system according to claim 15, wherein the second communication interface protocol is same as the first communication interface protocol.

17. The system according to claim 15, wherein the second communication interface protocol is different from the first communication interface protocol.

18. The system according to claim 15, further comprising:
a third display device connected in series to the second display device via a third communication interface protocol based on which a video signal is transmitted to the third display device via the second display device.

19. The system according to claim 18, wherein:
at least one of the first display device or the second display device is configured to, in response to a firmware update instruction for the third display device, transmit the target firmware update package to the third display device for the third display device to complete a target firmware update operation.

20. The system according to claim 18, wherein:
one of the first display device, the second display device, and the third display device that needs to perform a target firmware update operation is configured to complete the target firmware update operation based on different access paths in response to the first display device, the second display device, and the third display device being in different operating states.
